(19) United States
(12) Patent Application Publication
(10) Pub. No.: US 2022/0230066 A1
(43) Pub. Date: Jul. 21, 2022

(54) CROSS-DOMAIN ADAPTIVE LEARNING

(71) Applicant: QUALCOMM Incorporated, San Diego, CA (US)

(72) Inventors: Debasmit DAS, San Diego, CA (US); Fatih Murat PORIKLI, San Diego, CA (US); Sungrack YUN, Seongnam (KR)

(21) Appl. No.: 17/648,415

(22) Filed: Jan. 19, 2022

Related U.S. Application Data
(60) Provisional application No. 63/139,714, filed on Jan. 20, 2021.

(51) Int. Cl. G06N 3/08; G06F 7/76; G06N 3/04

(52) U.S. Cl. CPC G06N 3/08; G06N 3/0481; G06F 7/764

(57) ABSTRACT

Techniques for cross-domain adaptive learning are provided. A target domain feature extraction model is tuned from a source domain feature extraction model trained on a source data set, where the tuning is performed using a mask generation model trained on a target data set, and the tuning is performed using the target data set.

### CROSS-REFERENCE TO RELATED APPLICATIONS

This Application claims the benefit of and priority to U.S. Provisional Patent Application No. 63/139,714, filed Jan. 20, 2021, the entire contents of which are incorporated herein by reference.

### INTRODUCTION

Aspects of the present disclosure relate to cross-domain adaptive learning.

Machine learning has been applied for a wide variety of tasks, such as image recognition, speech (or speaker) identification, and the like. Generally, machine learning models (such as convolutional neural networks) are trained to learn the features of a particular domain. Consequently, such models typically do not generalize well beyond this limited domain, even to closely-related tasks. For example, a model trained to classify images of flowers is unlikely to perform well in classifying images of animals.

Further, training machine learning models typically requires a large number of training samples (often referred to as exemplars). If too few samples are available, trained model accuracy is generally poor. Efforts have been made to adapt existing models (trained for one domain using a large number of samples) for other domains where fewer samples are available. However, current approaches do not generalize well, and have shown limited accuracy even when adapted to similar domains. In particular, if the domains are more distinct, existing approaches to adapt trained models have failed to provide reasonable accuracy.

Accordingly, what is needed are more effective techniques to adapt models to perform accurately in different domains using few training samples in the target domain.

### BRIEF SUMMARY

Certain aspects provide a computer implemented method comprising: tuning a target domain feature extraction model from a source domain feature extraction model trained on a source data set, wherein: the tuning is performed using a mask generation model trained on a target data set, and the tuning is performed using the target data set.

Further aspects relate to apparatuses configured to perform the methods described herein as well as non-transitory computer-readable mediums comprising computer-executable instructions that, when executed by a processor of a device, cause the device to perform the methods described herein.

The following description and the related drawings set forth in detail certain illustrative features of one or more aspects.

### BRIEF DESCRIPTION OF THE DRAWINGS

The appended figures depict certain features of the various aspects and are therefore not to be considered limiting of the scope of this disclosure.

FIG. 1 depicts an example workflow for training a source domain feature extractor to serve as a backbone for a target domain feature extractor.

FIG. 2 depicts an example workflow for training a mask generator to aid adaptation to a target domain.

FIG. 3 depicts an example workflow for tuning a target domain feature extractor for a target domain.

FIG. 4 depicts an example workflow for using a trained domain feature extractor and classifier for a target domain.

FIG. 5 depicts an example flow diagram illustrating a method for training and tuning a machine learning model for a target domain.

FIG. 6 depicts an example flow diagram illustrating a method for training a source domain feature extractor.

FIG. 7 depicts another example flow diagram illustrating a method for training a mask generator.

FIG. 8 depicts another example flow diagram illustrating a method for training a target domain feature extractor and classifier.

FIG. 9 is a flow diagram illustrating a method for using a target domain feature extraction model to classify input data in a target domain.

FIG. 10 depicts another example flow diagram illustrating a method for training a target domain feature extraction model.

FIG. 11 depicts an example block diagram illustrating a processing system configured to train and tune machine learning models for target domains.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for adapting machine learning models to different domains using few training samples.

Conventional machine learning relies on a large number and variety of labeled training samples in order to avoid overfitting the model and to achieve reasonable accuracy during inferencing. For example, to train a neural network to accurately classify flowers in images, a large number of images, each with a corresponding label indicating which flower(s) are present, must be used to iteratively train and refine the network. If only a few such labeled samples are available, the model will tend to over-fit to the particular samples used and will perform poorly (e.g., with very low accuracy) for other new images.

In some aspects of the present disclosure, a feature extraction model is trained, using self-supervised techniques, for a source domain. In one aspect, self-supervised learning relies on the data itself to provide supervision, as opposed to human-created labels. By using such self-supervision and refraining from using labels of the training samples in the source domain (e.g., by refraining from using supervised learning), the feature extraction model learns to extract features of the input data rather than learning to classify the data, as in conventional supervised learning. In some aspects, this source domain feature extraction model can then be refined to serve as a domain feature extractor for a target domain using relatively few samples, in what may be referred to as “one-shot” learning (when a single sample is used) or “few-shot” learning (when a small number of samples are used). In aspects described herein, this transformation of a source domain feature extractor for a source domain to a target domain feature extractor for a target domain may be referred to as refining, training, tuning, fine-tuning, adapting, and the like.

In some aspects, in order to enhance the accuracy of the target model, the system can also train a mask generator (e.g., a layer, sub-network, or network model) to help select salient features from output of the source domain feature extractor based on the target domain. The generated mask(s) can improve training of the target source extractor by forcing it to focus on the selected features. This can help the model to generalize well by selectively using features that are predictive for the target domain, which can prevent over-fitting and reduce the number of target domain samples needed to achieve high accuracy and otherwise improved performance.

Advantageously, aspects of the present disclosure require relatively few training samples for the target domain to nevertheless achieve high task accuracy (e.g., classification). For example, while there may be many thousands of samples for the source domain, the target model may be trained using fewer than a hundred samples (including a single sample, five samples, ten samples, twenty samples, fifty samples, and so on in various implementations).

Such adaptation has wide applicability to improve the accuracy of machine learning models in domains where few exemplars are available. For example, in speaker verification (verifying the identity of an individual based on their voice), a model may be trained using source domain data (e.g., data from a first group of speakers), and then adapted to a target domain (e.g., related to a single, new speaker) using techniques described herein to provide improved verification accuracy even when there is a large difference in the speaking styles between the source and target domains.

As another example, a model may be trained to perform image recognition in a source domain (e.g., identifying flowers), and then adapted to a target domain with few samples (e.g., classifying satellite imagery, medical imagery, and the like).

Similarly, for image verification, such as to validate biometric data (e.g., face data, iris data, hand-writing styles, and the like), a generic model may be trained using source data and fine-tuned using target data for a particular user. For example, the techniques described herein may be used to train models to distinguish real and spoofed fingerprints where large differences may exist between the domains. As yet another example, advanced driver assistance systems may be refined to classify driver engagement levels using a relatively small number of samples of the particular driver's engagement.

In some aspects discussed herein, the source domain and target domain may each be modeled as a respective joint distributions P over the input space X and the label space [symbol] . The marginal distribution of the input space may be denoted as Pₓ. Generally, instances (x, y) can be sampled from P, where x is the input and y is the corresponding label. Accordingly, the source domain may be represented as (χₛ, [symbol] ₛ) and the target domain as (χₜ, [symbol] ₜ) with joint distributions Pₛ and Pₜ, respectively. In an aspect, due to the domain difference, the source marginal distribution P_{χ}_{ₛ} may be very different from the target marginal distribution P_{χ}_{ₜ}. Moreover, the classes in the target domain may be entirely novel (with no overlap between [symbol] ₛ and [symbol] ₜ). In aspects of the present disclosure, the system can first train a model using a relatively large amount of data sampled from the source distribution Pₛ. The model can then be adapted to a target domain based on a relative small amount of data sampled from the target distribution Pₜ.

Aspects of the present disclosure can be applied to a wide variety of machine learning tasks, and can generally improve the accuracy of models in any number of task domains.

### Example Workflow for Training a Source Domain Feature Extractor

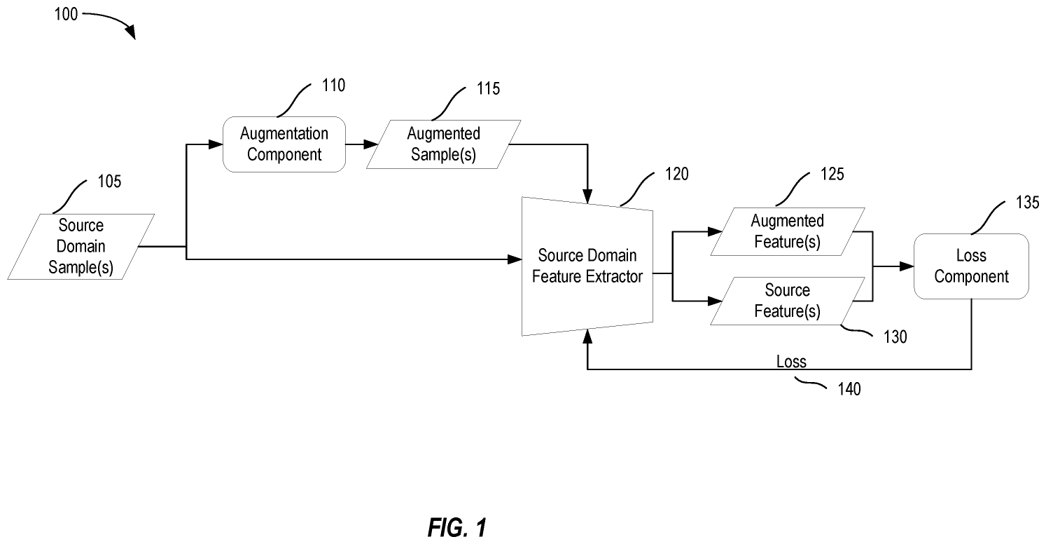

FIG. 1 depicts an example workflow 100 for training a source domain feature extractor 120 to serve as a backbone for a target domain feature extractor.

In FIG. 1, a set of source domain samples 105 are used to train a source domain feature extractor 120. In this example, the source domain samples 105 are training exemplars in a source domain where a relatively large number of samples are available (e.g., at least an order of magnitude more samples than are available in the target domain). For example, if the source domain corresponds to classification of animals, the source domain samples 105 may include images of animals. In some aspects, each source domain sample 105 is associated with a corresponding label indicating the class to which it belongs. However, during self-supervised learning, the labels (if present) may be ignored.

As illustrated, one or more of the source domain samples 105 may be provided directly as input to a source domain feature extractor 120, which outputs a set of source features 130 for each input source domain sample 105. Generally, the source features 130 are represented by a multi-dimensional tensor of values, where each dimension corresponds to a particular feature.

In an aspect, the source domain feature extractor 120 is a neural network (e.g., or a portion thereof, such as one or more layers of a neural network). For example, the source domain feature extractor 120 may correspond to a neural network including an input layer and one or more hidden layers, but without a fully-connected classifier or output layer. That is, the output from the last layer of the network may be a set of features (e.g., the source features 130) or an embedding, rather than a classification of the input data.

In workflow 100, an augmentation component 110 is used to augment the source domain samples 105 (e.g., in a training batch) using various transformations in order to generate augmented sample(s) 115. These transformations may include, for example, rotations, color conversion (e.g., to grayscale), translations, addition of noise, inversions, and the like. The transformations allow the system to learn the features of the source domain in a self-supervised manner, without relying on input labels.

In some aspects, a single augmented sample 115 is generated for each source domain sample 105. In other aspects, any number of augmented samples 115 can be generated for each source domain sample 105. As illustrated, each augmented sample 115 is processed by the source domain feature extractor 120 to generate a corresponding set of augmented features 125. In an aspect, the augmented features 125 have the same dimensionality as the source features 130. Although the illustrated workflow 100 depicts discrete augmented features 125 and source features 130 for conceptual clarity, the source domain feature extractor 120 is generally agnostic as to whether the input has been transformed, and the resulting features may otherwise be indistinguishable.

Loss component 135 can receive and process the augmented feature(s) 125 and the source feature(s) 130 associated with each source domain sample 105 in order to generate a loss 140. This loss 140 is used to refine the source domain feature extractor 120. Generally, any suitable self-supervised loss function may be used. In at least one aspect, the augmented samples and original samples are used to compute a contrastive loss 140, where the contrastive loss 140 is based at least in part on the differences or contrast between the source domain samples and augmented samples.

In an aspect, the workflow 100 may be performed using N_{b} training samples (source domain samples 105), where the samples are represented as {xᵢ}ᵢ₌₁^{N}^{_{b}}. For each sample xᵢ, the system may first obtain Nₜ random (or pseudo-random) transformations (resulting in Nₜ augmented samples 115), where the j^{th} transformed instance is represented as xᵢⱼ and j={1, 2 . . . , Nₜ}. In an aspect, the system can enforce the transformed instances xᵢⱼ to be close to xᵢ and far from xₖ, k≠i using a contrastive (e.g., cross-entropy) loss defined in Equation 1 below.

$${L}_{c o n} = - \frac{1}{{N}_{b} {N}_{t}} {\sum }_{i = 1}^{{N}_{b}} {\sum }_{j = 1}^{{N}_{t}} log \frac{exp ( - d ( {ϕ}_{s} ( {x}_{i j} ) , {ϕ}_{s} ( {x}_{i} ) ) )}{{\sum }_{k = 1}^{{N}_{b}} exp ( - d ( {ϕ}_{s} ( {x}_{i j} ) , {ϕ}_{s} ( {x}_{k} ) ) )} \qquad ( 1 )$$

In Equation 1, ϕₛ(⋅) is the source domain feature extraction model (e.g., 120 in FIG. 1), d(⋅) is a distance metric, N_{b} is a batch size of the source data set, Nₜ is a number of augmentations, xₖ is an original sample of the source data set, and xᵢⱼ is a transformed sample of the source data set. In one aspect, Euclidean distance is used as the distance metric d(⋅).

In aspects, this self-supervised loss (which is computed without consideration of the source labels) causes the source domain feature extractor 120 to learn more generally-applicable features that can be extended beyond the source domain.

### Example Workflow for Training a Mask Generator for a Target Domain

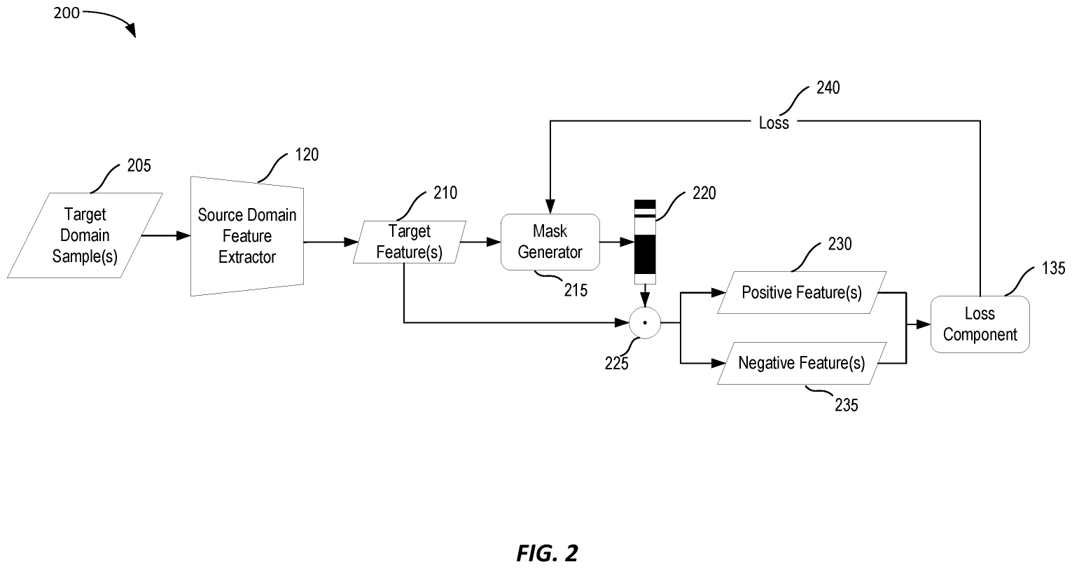

FIG. 2 depicts an example workflow 200 for training a mask generator to aid adaptation to a target domain.

Generally, workflow 200 can be used to generate one or more masks that select task-relevant features (e.g., features that help to classify and/or distinguish classes of input data in the target domain) and task-irrelevant features (e.g., features that do not help to distinguish between classes in the target domain). Use of such masks can improve the accuracy of the final models by allowing the system to generalize away from the original source domain and towards the target domain.

In FIG. 2, each sample of a set of target domain samples 205 are provided to the source domain feature extractor 120 (e.g., a neural network trained using the workflow 100 discussed above) to generate a corresponding set of target feature(s) 210 (e.g., in an embedding). In an aspect, the target features 210 have the same dimensionality as the source features 130 and augmented features 125 discussed with respect to FIG. 1.

Each target domain sample 205 is a training exemplar for the target domain. Generally, the target domain differs from the source domain in some material respect. For example, the target domain may include one or more classes which are absent from the source domain. In at least one aspect, the classes may be entirely discrete such that none of the classes of the target domain are present in the source domain, and vice versa.

In some aspects, the source and target domains may also differ in other ways. For example, the source domain may use color imagery while the target domain uses grayscale. Similarly, the source domain may use input data that includes perspective (e.g., images of animals that reflects the depth or dimensionality of the space) while the target domain has no such perspective (e.g., flat x-ray images).

The target features 210 are provided to a mask generator 215. The mask generator 215 may include a neural network that receives a set of input features (e.g., a tensor) and outputs a corresponding mask. The mask is generally of the same dimensionality as the input tensor (e.g., the same dimensionality as the target features 210), and specifies a value between zero and one for each feature. In some aspects, the value may be 1 or 0 for each feature, e.g., a binary output mask.

In one example, let the source domain feature extractor 120 (trained from the source domain) be denoted as ϕₛ(⋅). Given a batch of target domain samples 205 {(xᵢ, yᵢ)}ᵢ₌₁^{N}, for each sample the source domain feature extractor 120 can be used to generate target features 210 fᵢ=ϕₛ(xᵢ)ϵR^{d}. These features are input to the mask generator 215 (which may be represented as M(⋅)) to obtain the mask mᵢ=M(fᵢ).

In some aspects, the mask is converted to a binary mask 220. For example, the system may convert the mask into a binary mask by converting any values less than 0.5 to 0, and any values greater than or equal to 0.5 to 1 (or using some other cutoff). This way, the binary mask acts to selectively pass or suppress features from the input. In the example depicted in FIG. 2, the black portions of binary mask 220 represent one binary mask value (e.g., 1) and the white portions of binary mask 220 represent another binary mask value (e.g., 0).

In some aspects, generating the binary mask 220 includes adding logistic noise to the values of the mask, and applying a linear or nonlinear activation function to the resulting values. That is, to generate a binary mask mᵢⱼ, the system may use a probabilistic procedure. For example, let zᵢⱼ be the unbounded output logit from the mask generator 215 corresponding to the i^{th} sample and the j^{th} dimension. The system may generate logistic noise l such that l=log(u)−log(1−u) and u˜uniform(0,1). The noise may then be added to the logits to produce mask mᵢⱼ using Equation 2 below, where σ(⋅) is the sigmoid operation and τ is the temperature parameter.

$${m}_{ij} = σ ( \frac{{z}_{ij} + l}{τ} ) \qquad ( 2 )$$

The addition of noise to the logits may be used to test different binary masks suitable for the target task during training. To back-propagate discrete masks during training, the system may use a straight through estimator using Equation 2 during the backward pass and a hard threshold operation during the forward pass. In at least one aspect, the hard threshold operation involves setting mᵢⱼ to 1 if mᵢⱼ>0.5 or else 0. During inference mode, the hard threshold operation of the mask may be carried out with the logistic noise l=0 so the system can generate deterministic outputs.

As illustrated, the mask 220 (which may be a binary mask) is then applied to the target features 210 using an operation 225 to generate a set of positive features 230 and a set of negative features 235. In some aspects, task-relevant features may be referred to as positive features, while task-irrelevant features are referred to as negative features.

In at least one aspect, the operation 225 is an element-wise product (e.g., the Hadamard product) operation. In some aspects, given features fᵢ and mask mᵢ, the positive features 230 may be represented as fᵢ⁺=mᵢ⊙fᵢ, and the negative features 235 may be represented as fᵢ⁻=(1−mᵢ)⊙fᵢ, where ⊙ is the element-wise product, 1 is a vector or tensor of ones of the appropriate dimension (e.g., of equal dimensionality to the feature tensor), and mᵢϵ [symbol] ^{d} is a mask vector or tensor consisting of d elements where the j^{th} element is represented as mᵢⱼ.

As illustrated, the positive features 230 and negative features 235 are then processed by a loss component 135 to generate a loss 240, which is used to refine the mask generator 215.

Generally, the mask generator 215 is trained to ensure sure that the positive features 230 (fᵢ⁺) are discriminatory between the target classes, while the negative features (fᵢ⁻) are not. Thus, the mask generator 215 may be trained such that fᵢ⁺ and fᵢ⁻ are statistically divergent.

In some aspects, to produce discriminative positive features fᵢ⁺, the loss component 135 uses a cross-entropy loss function. For example, the system may process the positive features 230 using a linear classifier to generate a classification. This classification, along with the actual label for the corresponding target domain sample 205, may be used to compute cross-entropy loss, such as in Equation 3.

Lₚₒₛ(fᵢ⁺)=L_{XEnt}(C⁺(fᵢ⁺),yᵢ) (3)

In Equation 3, L_{XEnt}(⋅) is the cross-entropy criterion, C⁺(⋅) is a linear classifier used for the positive features fᵢ⁺, and yᵢ is the label for target domain sample 205 which was used to generate the target features fᵢ^{t}, which were then processed with the mask to generate positive features fᵢ^{t}.

In one aspect, to compute a loss based on the negative features 235 (fᵢ⁻), the loss component 135 uses a maximum entropy criterion as in Equation 4, below, where C⁻(⋅) is a linear classifier used for the negative features fᵢ⁻, and L_{Ent}(⋅) is the entropy of the softmax outputs of C⁻(fᵢ⁻).

L_{neg}(fᵢ⁻)=−L_{Ent}(C⁻(fᵢ⁻)) (4)

In some aspects, as discussed above, the loss component 135 further computes a loss to ensure the positive features 230 and the negative features 235 are statistically divergent. Thus, if s_{d}(⋅) is a statistical distance between the two sets of features (the positive set F⁺={(fᵢ⁺)ᵢ₌₁^{N}}) and the negative set (F⁻={(fᵢ⁻)ᵢ₌₁^{N}}), then the system may minimize the divergence loss using Equation 5, below. In one aspect, the exponent term in Equation 5 may be used to provide more stable and smaller gradients when close to optimality.

L_{div}(F⁺,F⁻)=e^{-s}^{_{d}}^{(F}^{⁺}^{,F}^{^{−}}⁾ (5)

In workflow 200, the loss component 135 can combine the positive loss, negative loss, and/or divergent loss in order to generate an overall loss 240, which is used to refine the mask generator 215. In at least one aspect, the loss terms defined above in Equations 3, 4, and 5 are weighted and combined to obtain an overall loss for the mask generator 215, as defined in Equation 6 below.

Lₘₐₛₖ=λₚₒₛLₚₒₛ+λ_{neg}L_{neg}+λ_{div}L_{div} (6)

In Equation 6, λₚₒₛ, λ_{neg}, and λ_{div} are the weights for each respective loss component. In one aspect, these weights are configurable hyperparameters. In another aspect, the weights are trainable parameters. For example, the weights λₚₒₛ, λ_{neg}, and λ_{div} may be learned using exponential decay and Lₘₐₛₖ may be defined as:

$$exp ( - {λ}_{p o s} ) {L}_{p o s} + exp ( - {λ}_{n e g} ) {L}_{n e g} + exp ( - {λ}_{d i v} ) {L}_{d i v} + \frac{{λ}_{p o s}}{2} + \frac{{λ}_{n e g}}{2} + \frac{{λ}_{d i v}}{2} .$$

Lₘₐₛₖ may then be averaged over the training samples in a given batch to obtain the final loss, which is back-propagated across M(⋅), C⁺(⋅) and C⁻(⋅) to update the respective parameters. In an aspect, the parameters of the source domain feature extractor 120 are frozen and unchanged during training of the mask generator 215.

In this way, the mask generator 215 is iteratively refined, based on samples in the target domain, to generate a mask given a set of input features.

### Example Workflow for Adapting a Source Domain Feature Extractor to Generate a Target Domain Feature Extractor

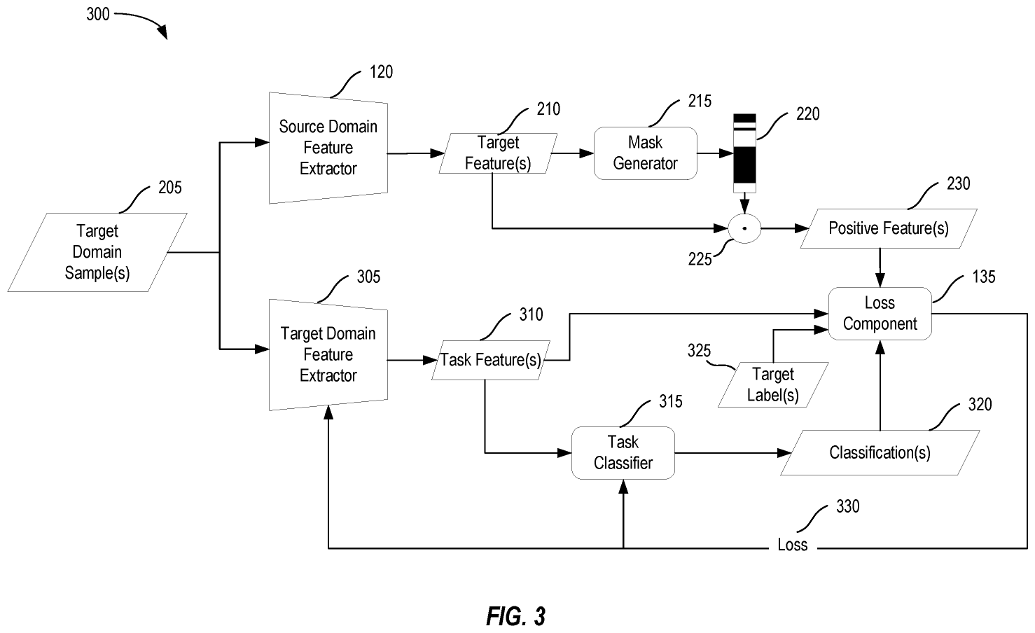

FIG. 3 depicts an example workflow 300 for tuning a target domain feature extractor 305 for a target domain. Workflow 300 may be used as a fine-tuning stage to adapt the target domain feature extractor 305 to the target domain. In the workflow 300, the target domain feature extractor 305 and a task classifier 315 are trained on the target domain data 205. As the target domain may only contains a relatively small number of labeled data samples, in some aspects, the system regularizes the target domain feature extractor 305 to generate positive features using the trained mask generator 215, as discussed in more detail below.

Target domain samples 205 are each passed through the trained source domain feature extractor 120 in order to generate corresponding target feature(s) 210 for each target domain sample 205. Each respective tensor of target features 210 is then passed through the trained mask generator 215 to generate a corresponding mask 220 (which may be a binary mask, as discussed above). Each mask 220 is then applied (e.g., using an element-wise product operation) to the respective target features 210 to yield a respective set of positive features 230.

Target domain feature extractor 305 may be a machine learning model (or portion thereof), such as a neural network, that is trained to extract features of input data (e.g., target domain samples 205). In one aspect, the target domain feature extractor 305 is initialized using the parameters of the trained source domain feature extractor 120. That is, while the source domain feature extractor 120 may be initialized with random values, the target domain feature extractor 305 may be initialized using the values of the trained source domain feature extractor 120. These parameters can then be refined or “tuned” in order to generate the trained target domain feature extractor 305. This allows the original source domain feature extractor 120 to be adapted to the target domain.

Let ϕₜ(⋅) be the target domain feature extractor 305 that is initialized from the parameters of the source domain feature extractor CO.

Given one or more target domain samples 205 for the target domain, the target domain feature extractor 305 is used to generate corresponding sets of task features 310. That is, given a batch of target domain samples {(xᵢ, yᵢ)}ᵢ₌₁^{N}, for each sample the system generates a feature tensor or vector fᵢ^{t}=ϕₜ(xᵢ)ϵR^{d}.

In FIG. 3, for each target domain sample 205, the corresponding target features 310 and positive features 230 are used by the loss component 135 to compute a loss 330. In some aspects, as discussed above, the loss component 135 generates the loss 330 to regularize the target domain feature extractor 305 based on the relevant or salient features (e.g., to ensure the feature domain of the target domain feature extractor 305 is similar to the features of the positive feature tensor 230).

In some cases, to ensure that the target domain feature fᵢ^{t} is close to the relevant (positive) features, the system can generate a relevant target tensor or vector fᵢ⁺=M(ϕₛ(xᵢ))⊙ϕₛ(xᵢ). The regularization loss can then be defined using Equation 7 below, where ∥⋅∥₂ is the Euclidean distance of the tensor or vector from the origin (also referred to as the Euclidean norm or the 2-norm).

L_{reg}=∥fᵢ^{t}−fᵢ⁺∥₂² (7)

In workflow 300, the task features 310 are also provided to a task classifier 315. The task classifier 315 and target domain feature extractor 305 may each be a neural network model, or may be different aspects of a single a neural network model. For example, the target domain feature extractor 305 may be used as one or more initial layers (e.g., an input layer and one or more internal hidden layers), while the task classifier 315 may comprise one or more fully connected layers at the end of the network used to classify the features.

Each set of task features 310 is provided to the task classifier 315 to generate a corresponding classification 320. That is, the feature fᵢ^{t} can be provided as input to the task classifier 315 (C(⋅)) to generate a classification 320. In one aspect, the task classifier 315 is a linear classifier (e.g., a classifier that classifies input data based on a linear combination of input features).

The loss component 135 may compute the loss 330 based at least in part on a cross-entropy loss between the classification 320 and the corresponding target label 325 for the original input target domain sample 205. This cross-entropy loss may be computed using Equation 8, below.

Lₜₐₛₖ(fᵢ^{t})=L_{XEnt}(C(fᵢ^{t}),yᵢ) (8)

In Equation 8, L_{XEnt}(⋅) is the cross-entropy criterion, C(⋅) is a linear classifier used for the target features fᵢ^{t}, and yᵢ is the label for target domain sample 205 which was used to generate the target features fᵢ^{t}.

As illustrated, the regularization loss L_{reg} (computed using the task features 310 and the positive features 230) and the task loss (computed using the target labels and the classifications) can be weighted and combined to obtain the overall loss 330, which may be defined using Equation 9 below.

L_{ft}=Lₜₐₛₖ+λ_{reg}L_{reg} (9)

In Equation 9, λ_{reg} is a weighting value to adjust the contribution of each loss component. In one aspect, this weight is a configurable hyperparameter. In another aspect, λ_{reg} may be a trainable parameter. For example, λ_{reg} may be learned using exponential decay and L_{ft} may be defined as

$${L}_{t a s k} + exp ( - {λ}_{reg} ) {L}_{reg} + \frac{{λ}_{r e g}}{2} .$$

L_{ft} may be averaged over the training samples in a given batch to obtain the final loss for the batch or training epoch, and the loss may then be back-propagated across ϕₜ(⋅) (the target domain feature extractor 305) and C(⋅) (the task classifier 315) to update their respective parameters. Generally, the parameters of the source domain feature extractor 120 and mask generator 215 are not updated during training of the target domain feature extractor 305 and task classifier 315.

After the training samples 205 have been used to refine the target domain feature extractor 305 and task classifier 315, the target feature extractor 305 and task classifier 315 can be used to classify new input data for the target domain without use of the source domain feature extractor 120 or mask generator 215. Advantageously, because the target domain feature extractor 305 was instantiated from the source domain feature extractor 120, which was trained using a large amount of source data, it can extract features with more accuracy and diversity than if solely the target domain data was used. Additionally, by starting from a trained source domain feature extractor (rather than a randomly-instantiated model), training of the target domain feature extractor can be performed with significantly fewer computing resources and requires less time. Further, because self-supervision may be used to train the source domain feature extractor 120, it may generalize well for dissimilar domains. Moreover, by training and using the mask generator 215 based on the target domain samples, the source domain feature extractor 120 can be tuned specifically for the target domain, which significantly increases the resulting accuracy of the model.

### Example Workflow for Using a Trained Target Domain Feature Extractor and Classifier

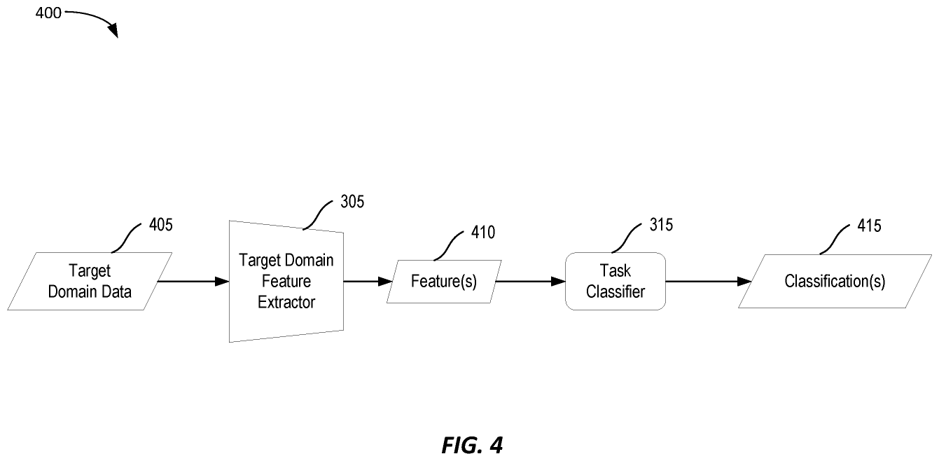

FIG. 4 depicts an example workflow 400 for using a trained target domain feature extractor 305 and classifier 315 for a target domain.

In this example, the target domain feature extractor 305 and task classifier 315 have been trained using one or more labeled samples in the target domain. Although depicted as discrete components for conceptual clarity, in some aspects, the target domain feature extractor 305 and task classifier 315 are implemented using a single neural network or other type of machine learning model.

Once the target domain feature extractor 305 and task classifier 315 are trained and deployed for use, target domain data 405 can be provided to the target domain feature extractor 305. Generally, target domain data 405 is unlabeled or unclassified input data that is received or captured for classification in the target domain (assuming that classification is the desired task). For example, if the target domain is to classify medical anomalies in medical imagery, the target domain data 405 may include one or more images (e.g., x-ray or MRI images) that may or may not include such anomalies.

Target domain feature extractor 305 processes each sample of target domain data 405 to generate a corresponding set of features 410. As discussed above, this set of features 410 may comprise a multidimensional set of numerical values (e.g., in a vector or tensor). These features 410, in turn, are provided to the task classifier 315, which outputs a classification 415 for each set of input features 410. For example, classification 415 may categorize the target domain data 405 into one or more classes in the target domain.

Generating the classification 415 using the workflow 400 may be represented as C(ϕₜ(xₜₑ)), where xₜₑ is a test sample (e.g., the target domain data 405), ϕₜ(⋅) is the target domain feature extractor 305, and C(⋅) is the task classifier 315. In some aspects, a softmax operation may be used on the output of C(ϕₜ(xₜₑ)) in order to obtain the individual class probabilities. Based on these probabilities, the most probable class can be selected and output as the classification 415 for the input target domain data 405.

### Example Method for Training a Machine Learning Model for a Target Domain

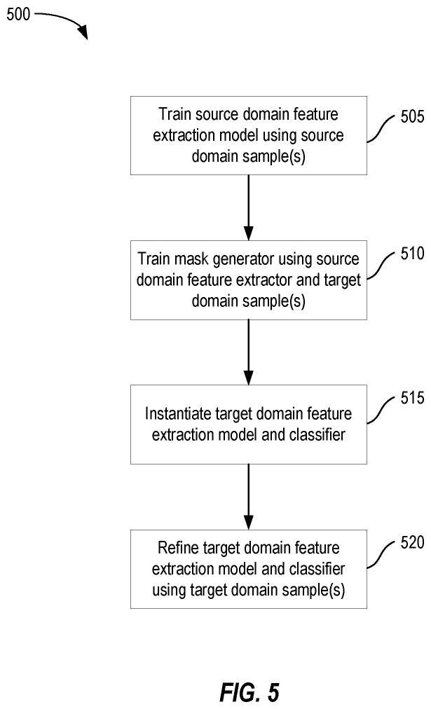

FIG. 5 is an example flow diagram illustrating a method 500 for training and tuning a machine learning model for a target domain.

The method 500 begins at block 505, where a training system trains a source domain feature extractor (e.g., source domain feature extractor 120 of FIGS. 1-3) using a set of source domain samples (e.g., source domain samples 105 of FIG. 1). As discussed above, the source domain samples generally correspond to training data for a source domain. The source domain samples may or may not have associated labels.

Training the source domain feature extractor generally comprises using a self-supervised loss function, which does not consider the labels of the source domain samples, to refine the source domain feature extractor. In at least one aspect, the self-supervised loss function is a contrastive lost (e.g., a loss computed based on the contrast between sets of data) computed based on the source domain samples and a corresponding set of augmented or transformed samples, as discussed above.

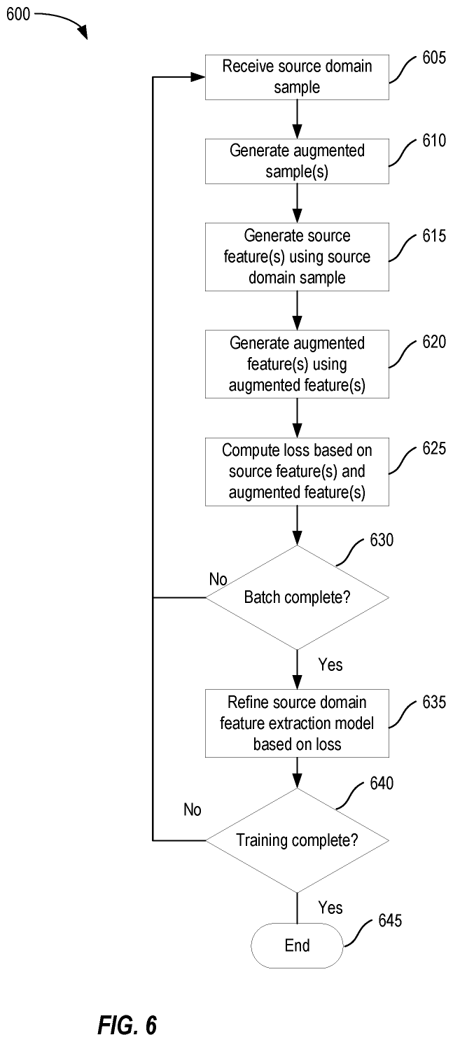

In aspects, training the source domain feature extractor may be performed using stochastic gradient descent, using a set of training batches, and the like. The process of training the source domain feature extractor is described in more detail below with reference to FIG. 6.

At block 510, the training system trains a mask generator (e.g., mask generator 215 of FIG. 2) using the source domain feature extractor and a set of target domain samples (e.g., target domain samples 205 of FIGS. 2-3). The target domain samples generally correspond to labeled training data for a target domain. In some aspects, although the source and target domains may generally relate to similar tasks (e.g., both involve classifying images), the source and target domains may be relatively divergent. That is, the distribution of the input data may differ substantially in each domain. Additionally, the relevant classes for each domain may be entirely non-overlapping.

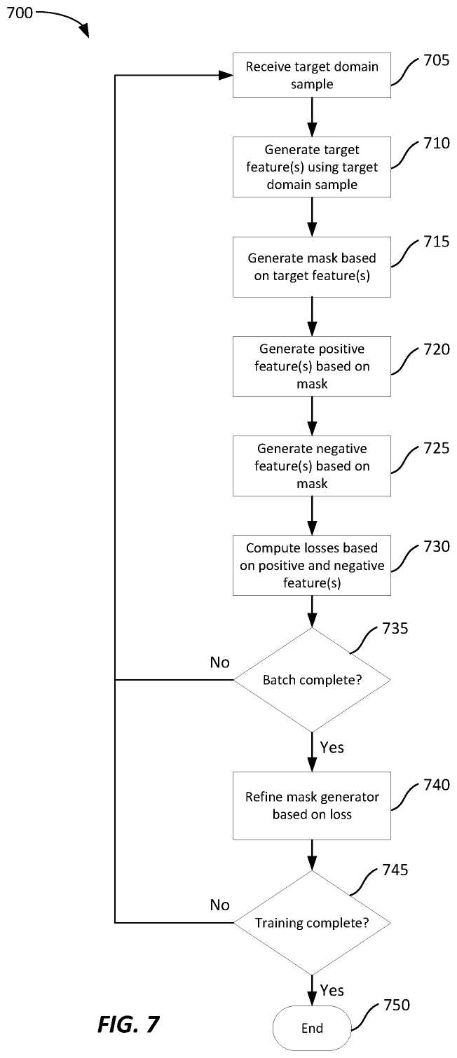

The mask generator generates an output mask (which may be a binary mask, or may be converted to a binary mask) that can be used to select and suppress particular features output by the source domain feature extractor when training models for the target domain. As discussed above, use of the mask generator can help the model learn to adapt to the target domain. In aspects, training the mask generator may be performed using stochastic gradient descent, using a set of training batches, and the like. The process of training the mask generator is described in more detail below with reference to FIG. 7.

At block 515, the training system instantiates a target domain feature extractor (e.g., target domain feature extractor 305) and a task classifier (e.g., task classifier 315). In some aspects, the target domain feature extractor is instantiated using the parameters of the source domain feature extractor. That is, rather than using random or pseudo-random values to initialize the parameters of the target domain feature extractor, the parameters of the source domain feature extractor can be used. As above, this can reduce the time and computing resources needed to train the target domain feature extractor, as fewer samples are used. Further, by adapting from the source feature extractor, the accuracy of the target domain feature extractor is improved, as compared to a target domain feature extractor trained from a random initialization.

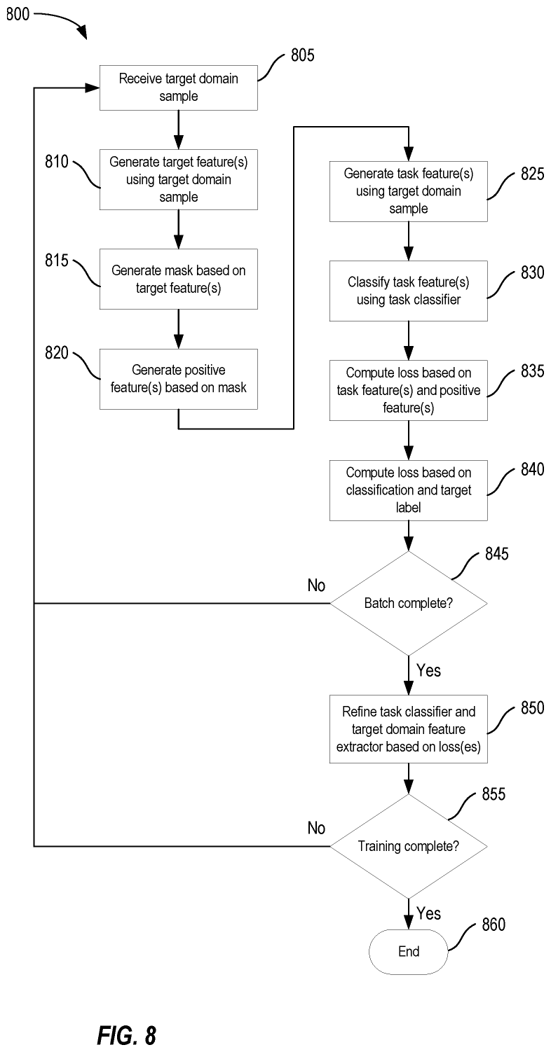

The method 500 then continues to block 520, where the training system refines (or trains) the target domain feature extractor and classifier using the labeled target domain samples. In some aspects, the system uses the mask generator to help refine the parameters of the target domain feature extractor and/or classifier, as discussed above. In aspects, training the target domain feature extractor and the task classifier may be performed using stochastic gradient descent, using a set of training batches, and the like. The process of training the target domain feature extractor and classifier is described in more detail below with reference to FIG. 8.

### Example Method for Training a Source Domain Feature Extraction Model

FIG. 6 is a flow diagram illustrating an example method 600 for training a source domain feature extractor. In one aspect, the method 600 provides additional detail for block 505 in FIG. 5.

The method 600 begins at block 605, where a training system receives a source domain sample. As discussed above, the source domain sample is generally some form of input data for a source domain. The source domain sample may or may not include a label or classification, as the training system does not use the labels during training.

For example, in an image classification task, the source domain sample may include an image. Similarly, for a voice recognition or verification task, the source domain sample may include audio of a user speaking. For a driver alertness task, the source domain sample may include data related to a driver's state (e.g., eye movement, head orientation, grip, and the like).

At block 610, the training system generates one or more augmented samples (e.g., augmented samples 115 in FIG. 1, also referred to as transformed samples) based on the source domain sample. In some cases, generating the augmented sample(s) includes applying one or more transformations to the source domain sample (e.g., rotations, translations, crops, additive noise, color changes, inversions, and the like) randomly or pseudo-randomly. In an aspect, the number of augmented samples, as well as the type and scale of the transformations, can be controlled using configurable hyperparameters.

At block 615, the training system uses the source domain feature extractor to generate a tensor of source features for the received source domain sample. The source feature tensor is a multi-dimensional tensor or vector of numeric values, where each dimension in the tensor corresponds to a respective feature. In an aspect, the size of the feature tensor (e.g., the number of features) is a configurable hyperparameter of the training system.

At block 620, the training system similarly generates, for each respective augmented sample, a respective set of augmented features (e.g., augmented features 125 in FIG. 1). The training system does so by providing each augmented sample as input to the source domain feature extractor. In aspects, the size or dimensionality of the set of augmented features matches the size or dimensionality of the source features.

The method 600 then continues to block 625, where the training system computes one or more measures of loss based on the source feature(s) and augmented feature(s). In some aspects, the training system computes a contrastive loss using the source features and set(s) of augmented features. For example, the training system may use Equation 1 (above) to compute the measure of loss based on the received source domain sample.

At block 630, the training system determines whether the current batch is complete. Generally, the size of each batch is a configurable hyperparameter. If the batch is not complete, the method 600 returns to block 605 to process the next source domain sample.

If, at block 630, the training system determines that the current batch has completed, the method 600 continues to block 635, where the training system refines one or more parameters of the source domain feature extractor based on the computed loss. For example, the training system may determine an aggregate loss based on the loss(es) generated for each source domain sample in the batch (e.g., by averaging the losses). In some aspects, the training system refines the source domain feature extractor by using back propagation techniques to refine the internal parameters of the model.

The method 600 then continues to block 640, where the training system determines whether training of the source domain feature extractor is complete. In various aspects, training completion may be defined using a variety of termination criteria. For example, the termination criteria may include a defined number of batches or epochs, a length of time spent training the extractor, a model accuracy on testing and/or validation data, and the like.

If training is not complete, the method 600 returns to block 605 to begin the next batch of training. If, at block 640, the training system determines that training of the source domain feature extractor is complete, the method 600 terminates at block 645. Once this source domain feature extractor has thus been trained for the source domain, it can be used to train a mask generator and refined to generate a target domain feature extractor, as discussed above.

### Example Method for Training a Mask Generator for a Target Domain

FIG. 7 is an example flow diagram illustrating a method 700 for training a mask generator. In one aspect, the method 700 provides additional detail for block 510 in FIG. 5.

The method 700 begins at block 705, where a training system receives a target domain sample. As discussed above, the target domain sample is generally some form of input data for a target domain. In an aspect, the target domain sample is associated with a label or other classification.

For example, in an image classification domain, the target domain sample may include an image and a corresponding label indicating the correct class for the image. Similarly, for a voice recognition or verification domain, the target domain sample may include audio of a user speaking, as well as a label or indication as to the identity of the speaker (or whether the speaker is verified). For a driver alertness domain, the target domain sample may include data related to a driver's state (e.g., eye movement, head orientation, grip, and the like), as well as an indication as to whether the driver was sufficiently alert when the data was collected.

At block 710, the training system uses the source domain feature extractor to generate a set of target features for the received target domain sample. In an aspect, the set of target features is a multi-dimensional tensor of numeric values, where each dimension in the tensor corresponds to a respective feature. In some cases, the size of the target feature tensor (e.g., the number of features) matches the size of the source features discussed above, and is a configurable hyperparameter of the training system.

At block 715, the training system generates a mask (e.g., 220 in FIG. 2) based on the target features. In one aspect, the training system does so by providing the target features as input to a mask generator, which may be a neural network. The mask is generally a set of values ranging from zero to one, where the size or dimensionality of the mask matches the size or dimensionality of the target features. That is, for each feature or dimension in the target feature set, there is a corresponding value in the mask.

In some aspects, the mask can be used to generate a binary mask. That is, while the generated mask may include various values between zero and one, the training system may generate a binary mask that includes only zero or one for each value. In some aspects, converting the mask to the binary mask involves comparing each value to a threshold (e.g., setting all values less than 0.5 to zero, and all other values to one). In some aspects, the training system can add logistic noise to the mask (e.g., using Equation 2 above), followed by application of an activation function to set the values for each dimension.

At block 720, the training system generates a set of positive features (e.g., 230 in FIG. 2) by applying the mask (e.g., a binary mask) to the target features. In an aspect, the positive features are generated by computing an element-wise product between the mask and the target features, as discussed above.

Additionally, at block 725, the training system generates a set of negative features (e.g., 235 in FIG. 2) by applying the (binary) mask to the target features. In an aspect, the negative features are generated by computing an element-wise product between the negation of the mask and the target features, as discussed above.

The method 700 continues to block 730, where the training system computes one or more measures of loss based on the positive feature(s) and/or negative feature(s). In some aspects, the training system computes three measures of loss using the positive and negative features: a positive loss based on the positive features, a negative loss based on the negative features, and a divergence loss based on the positive and negative features.

In at least one aspect, the training system computes a positive loss using one or more minimum cross-entropy techniques, such as by using Equation 3, above. Similarly, the training system may compute the negative loss using one or more maximum entropy techniques, such as by using Equation 4, above. Further, the training system may compute the divergence loss using one or more maximum mean discrepancy techniques, such as by using Equation 5, above.

In some aspects, the training system can then compute an overall loss for the training process by aggregating the individual measures of loss. For example, the training system may sum the individual loss components together. In some aspects, this sum is a weighted-aggregate (e.g., using Equation 6, above), where the particular weights to apply to each component of the loss may be a trainable parameter or a configurable hyperparameter.

At block 735, the training system can then determine whether the current training batch is complete. In an aspect, the size of each batch is a configurable hyperparameter. If the batch is not complete, the method 700 returns to block 705 to process the next target domain sample.

If, at block 735, the training system determines that the current batch has completed, the method 700 continues to block 740, where the training system refines one or more parameters of the mask generator based on the computed loss. For example, the training system may determine an aggregate loss based on the loss(es) generated for each target domain sample in the batch (e.g., by averaging the losses). In some aspects, the training system refines the mask generator by using back propagation techniques to refine the internal parameters of the model. As above, while the mask generator is refined, the parameters of the source domain feature extraction model may remain unchanged.

The method 700 then continues to block 745, where the training system determines whether training of the mask generator is complete. In various aspects, training completion may be defined using a variety of termination criteria. For example, the termination criteria may include a defined number of batches or epochs, a length of time spent training the mask generator, a threshold loss is attained, and the like.

If training is not complete, the method 700 returns to block 705 to begin the next batch of training. If, at block 745, the training system determines that training of the mask generator is complete, the method 700 terminates at block 750. Once this mask generator has thus been trained for the target domain, it can be used to refine the source domain feature extractor in order to generate a target domain feature extractor, as discussed above.

### Example Method for Training a Target Feature Extraction and Classifier Model

FIG. 8 is a flow diagram illustrating an example method 800 for training a target domain feature extractor and classifier. In one aspect, the method 800 provides additional detail for block 520 in FIG. 5.

The method 800 begins at block 805, where a training system receives a target domain sample. As discussed above, the target domain sample is generally some form of input data for a target domain. In an aspect, the target domain sample is associated with a label or other classification.

At block 810, the training system uses the source domain feature extractor to generate a set of target features for the received target domain sample. As discussed above, the set of target features may be a multi-dimensional tensor of numeric values, where each dimension in the tensor corresponds to a respective feature.

At block 815, the training system generates a mask by processing the target features using the mask generator. In aspects, the generated mask may be a set of values ranging from zero to one, or may be a binary mask (which may be generated based on the continuous mask).

The method 800 then continues to block 820, where the training system generates a set of positive features by applying the (binary) mask to the generated target features. As discussed above, this may be performed by computing an element-wise product between the (binary) mask and the target features, as discussed above.

At block 825, the training system generates a set of task features using the target domain sample. The task features are generated by processing the target domain sample using the target domain feature extractor. In some aspects, the target domain feature extractor is initialized using the parameters of the (trained) source domain feature extractor. Initially, the target domain feature extractor is aligned with the source domain feature extractor and the outputs will be identical (or similar). However, as training progresses and the parameters of the target domain feature extractor are refined for the target domain (while the parameters of the source domain feature extractor remain fixed), their outputs will diverge.

At block 830, the training system classifies the generated task features using a task classifier, as discussed above. The method 800 then continues to block 835.

At block 835, the training system computes one or more measures of loss based on the generated task feature(s) and the set of positive feature(s). This loss component may be used to regularize the target domain feature extractor based on the features selected by the generated mask. As the mask generator was trained using the target domain samples, the target domain feature extractor is thereby adapted to the target domain. In at least one aspect, the training system computes the feature loss using one or more distance techniques, such as by using Equation 7, above.

At block 840, the training system can similarly compute one or more measures of loss based on the generated task feature(s) and the generated classification(s) for the target domain sample. In at least one aspect, the training system computes this task loss using one or more minimum cross-entropy techniques, such as by using Equation 8, above.

In some aspects, the training system can then compute an overall loss for the training process by aggregating the individual measures of loss. For example, the training system may sum the individual loss components together. In some aspects, this sum is a weighted-aggregate (e.g., using Equation 9, above), where the particular weights to apply to each component of the loss may be a trainable parameter or a configurable hyperparameter.

At block 845, the training system can then determine whether the current training batch is complete. In an aspect, the size of each batch is a configurable hyperparameter. If the batch is not complete, the method 800 returns to block 805 to process the next target domain sample.

If, at block 845, the training system determines that the current batch has completed, the method 800 continues to block 850, where the training system refines one or more parameters of the task classifier and target domain feature extractor based on the computed loss. For example, the training system may determine an aggregate loss based on the loss(es) generated for each target domain sample in the batch (e.g., by averaging the losses). In some aspects, the training system refines the task classifier and target domain feature extractor by using back propagation techniques to refine the internal parameters of the models. In aspects, while the target domain feature extractor and task classifier are refined, the parameters of the source domain feature extraction model and mask generator are fixed.

The method 800 then continues to block 855, where the training system determines whether training of the target domain feature extractor and task classifier is complete. In various aspects, training completion may be defined using a variety of termination criteria. For example, the termination criteria may include a defined number of batches or epochs, a length of time spent training the models, and the like.

If training is not complete, the method 800 returns to block 805 to begin the next batch of training. If, at block 855, the training system determines that training of the task classifier and target domain feature extractor is complete, the method 800 terminates at block 860. The target domain feature extractor and task classifier can then be used to classify new input data for the target domain, as discussed above.

### Example Method for Training a Machine Learning Model for a Target Domain

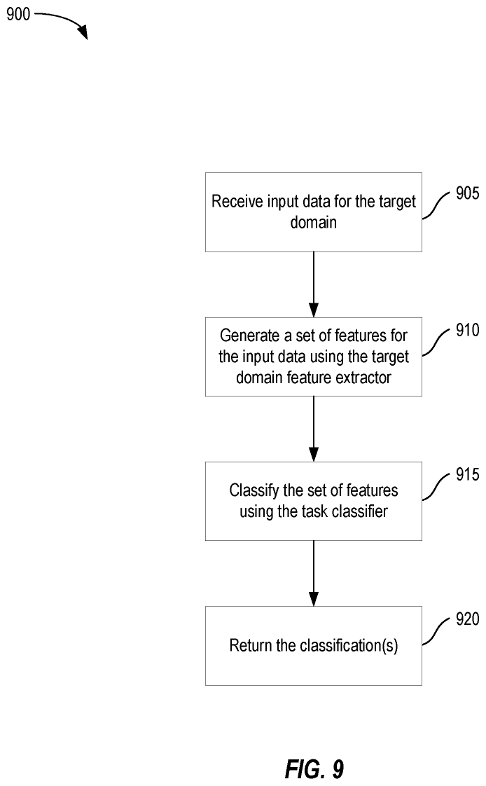

FIG. 9 is a flow diagram illustrating a method 900 for using a target domain feature extraction model to classify input data in a target domain, according to some aspects disclosed herein.

The method 900 begins at block 905, where an inference system receives input data in a target domain. In some aspects, the inference system is a discrete system that uses trained target models (e.g., trained by the training system discussed above with reference to FIGS. 1-3 and 5-8). In other aspects, inferencing and training may be performed using a single system or device. Generally, the input data corresponds to unlabeled data (such as the Target Domain Data 405 of FIG. 4) that is received or collected for classification.

At block 910, the inference system generates a set of features for the input data using the target domain feature extractor. For example, the inference system may process the input data using a target domain feature extractor trained and tuned using techniques discussed above with reference to FIGS. 1-3 and 5-8.

At block 915, the inference system can classify the generated set of features using a task classifier. For example, the inference system may process the set of features using a task classifier that was trained using techniques discussed above with reference to FIGS. 1-3 and 5-8.

At block 920, the inference system returns the generated classification(s) for the input data. In this way, the inference system can use models in a target domain, where the models were trained in a source domain and adapted to the target domain, to generate classifications. This improves the functioning of the models and the inference system by enabling more accurate classifications with reduced need for training samples in the target domain.

### Example Method for Training a Machine Learning Model for a Target Domain

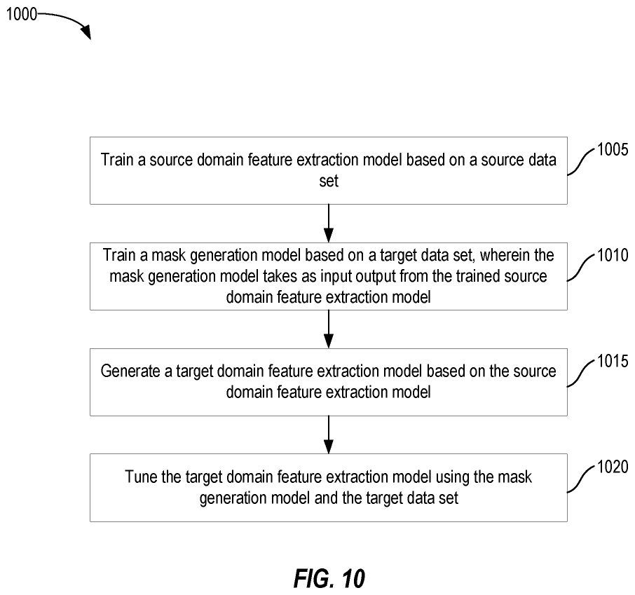

FIG. 10 is a flow diagram illustrating a method 1000 for training a target domain feature extraction model (e.g., 305 in FIG. 3), according to some aspects disclosed herein.

The method 1000 begins at block 1005, where a training system trains a source domain feature extraction model based on a source data set.

In some aspects, the source domain feature extraction model is trained using a self-supervised loss function. In some aspects, the self-supervised loss function comprises a contrastive loss function.

In some aspects, the method 1000 further comprises augmenting the source data set by performing one or more transformations on one or more samples of the source data set. Additionally, in some aspects, the contrastive loss function comprises Equation 1, above.

At block 1010, the training system trains a mask generation model (e.g., 215 in FIG. 2) based on a target data set, wherein the mask generation model takes as input output from the trained source domain feature extraction model.

In some aspects, training the mask generation model comprises generating a set of positive features based on the target data set and the mask generation model, and generating a set of negative features based on the target data set and the mask generation model.

Additionally, in some aspects, the method 1000 further comprises generating set of masks (e.g., 220 in FIG. 2) using the mask generation model, and generating a set of binary masks based on the set of masks. In some aspects, generating the set of binary masks based on the set of masks comprises adding logistic noise to the set of masks applying a nonlinear activation function to the set of masks. In at least one aspect, the nonlinear activation function comprises a sigmoid function.

In some aspects, the mask generation model is trained using a loss function comprising a cross-entropy loss component based on the set of positive features. Additionally, in some aspects, the loss function further comprises a maximum entropy loss component based on the set of negative features. Further, in some aspects, the loss function further comprises a divergence loss component based on the set of positive features and the set of negative features.

In some aspects, the loss function further comprises a first weighting parameter for the cross-entropy loss component, a second weighting parameter for the maximum entropy loss component, and a third weighting parameter for the divergence loss component.

At block 1015, the training system generates a target domain feature extraction model (e.g., 305 in FIG. 3) based on the source domain feature extraction model. In some aspects, the target domain feature extraction model comprises a neural network model.

At block 1020, the training system tunes the target domain feature extraction model using the mask generation model and the target data set.

In some aspects, the target domain feature extraction model is trained using a loss function comprising a regularization loss component. In at least one aspect, wherein the regularization loss component comprises a Euclidean distance function. Additionally, in some aspects, wherein the loss function further comprises a cross-entropy loss component.

In some aspects, for a given sample, the cross-entropy loss component is configured to generate a cross-entropy loss value based on a positive feature generated by the mask generation model based on the given sample and a classification output generated by a linear classification model based on the given sample.

In at least one aspect, the loss function further comprises a weighting parameter for the regularization loss component.

In some aspects, the method 1000 further comprises generating an inference using the target domain feature extraction model.

### Example System for Adaptive Machine Learning

In some aspects, the methods and workflows described with respect to FIGS. 1-10 may be performed on one or more devices. For example, training and inferencing may be performed by a single device or distributed across multiple devices. Often a model will be trained on a powerful computing device and then deployed to other less powerful devices (e.g., mobile devices) to perform inferencing.

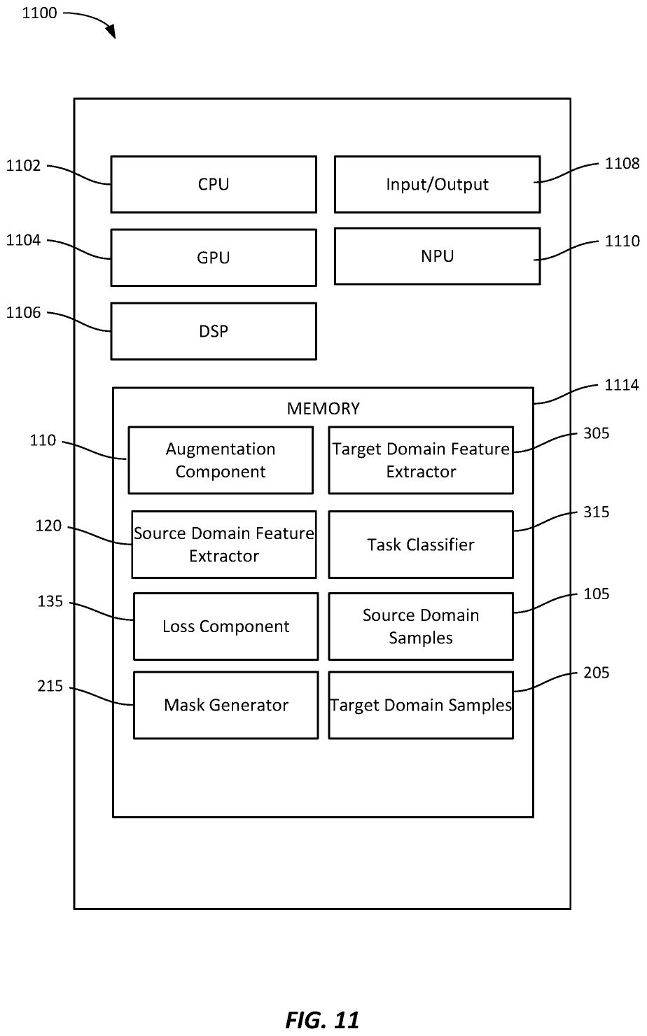

FIG. 11 is a block diagram illustrating a processing system 1100 which may be configured to perform aspects of the various methods described herein, including, for example, the methods described with respect to FIGS. 1-10.

Processing system 1100 includes a central processing unit (CPU) 1102, which in some examples may be a multi-core CPU. Instructions executed at the CPU 1102 may be loaded, for example, from a program memory associated with the CPU 1102 or may be loaded from a memory 1114.

Processing system 1100 also includes additional processing components tailored to specific functions, such as a graphics processing unit (GPU) 1104, a digital signal processor (DSP) 1106, and a neural processing unit (NPU) 1110.

Though not depicted in FIG. 11, NPU 1110 may be implemented as a part of one or more of CPU 1102, GPU 1104, and/or DSP 1106.

The processing system 1100 also includes input/output 1108. In some aspects, the input/output 1108 can include one or more network interfaces, allowing the processing system 1100 to be coupled to a one or more other devices or systems via a network (such as the Internet).

Although not included in the illustrated aspect, the processing system 1100 may also include one or more additional input and/or output devices 1108, such as screens, physical buttons, speakers, microphones, and the like.

Processing system 1100 also includes memory 1114, which is representative of one or more static and/or dynamic memories, such as a dynamic random access memory, a flash-based static memory, and the like. In this example, memory 1114 includes computer-executable components, which may be executed by one or more of the aforementioned processors of processing system 1100.

In this example, memory 1114 includes an augmentation component 110, a source domain feature extractor 120, a loss component 135, a mask generator 215, a target domain feature extractor 305, and a task classifier 315. The depicted components, and others not depicted, may be configured to perform various aspects of the methods described herein. The memory 1114 also includes a set of source domain samples 105 and target domain samples 205, as discussed above.

### Example Clauses

Clause 1: A method, comprising: training a source domain feature extraction model based on a source data set; training a mask generation model based on a target data set, wherein the mask generation model takes as input output from the trained source domain feature extraction model; generating a target domain feature extraction model based on the source domain feature extraction model; and tuning the target domain feature extraction model using the mask generation model and the target data set.

Clause 2: The method of Clause 1, wherein the source domain feature extraction model is trained using a self-supervised loss function.

Clause 3: The method of any one of Clauses 1-2, wherein the self-supervised loss function comprises a contrastive loss function.

Clause 4: The method of any one of Clauses 1-3, further comprising augmenting the source data set by performing one or more transformations on one or more samples of the source data set.

Clause 5: The method of any one of Clauses 1-4, wherein the contrastive loss function comprises

$${L}_{c o n} = - \frac{1}{{N}_{b} {N}_{t}} {\sum }_{i = 1}^{{N}_{b}} {\sum }_{j = 1}^{{N}_{t}} log \frac{exp ( - d ( {ϕ}_{s} ( {x}_{i j} ) , {ϕ}_{s} ( {x}_{i} ) ) )}{{\sum }_{i = 1}^{{N}_{b}} exp ( - d ( {ϕ}_{s} ( {x}_{i j} ) , {ϕ}_{s} ( {x}_{k} ) ) )} , \qquad$$

wherein ϕₛ(⋅) is the source domain feature extraction model, d(⋅) is a distance metric, N_{b} is a batch size of the source data set, Nₜ is a number of augmentations, xₖ is an original sample of the source data set, and xᵢⱼ is a transformed sample of the source data set.

Clause 6: The method of any one of Clauses 1-5, wherein training the mask generation model comprises: generating a set of positive features based on the target data set and the mask generation model; and generating a set of negative features based on the target data set and the mask generation model.

Clause 7: The method of any one of Clauses 1-6, further comprising: generating a set of masks using the mask generation model; and generating a set of binary masks based on the set of masks.

Clause 8: The method of any one of Clauses 1-7, wherein generating the set of binary masks based on the set of masks comprises: adding logistic noise to the set of masks; and applying a nonlinear activation function to the set of masks.

Clause 9: The method of any one of Clauses 1-8, wherein the nonlinear activation function comprises a sigmoid function.

Clause 10: The method of any one of Clauses 1-9, wherein the mask generation model is trained using a loss function comprising a cross-entropy loss component based on the set of positive features.

Clause 11: The method of any one of Clauses 1-10, wherein the loss function further comprises a maximum entropy loss component based on the set of negative features.

Clause 12: The method of any one of Clauses 1-11, wherein the loss function further comprises a divergence loss component based on the set of positive features and the set of negative features.

Clause 13: The method of any one of Clauses 1-12, wherein the loss function further comprises: a first weighting parameter for the cross-entropy loss component; a second weighting parameter for the maximum entropy loss component; and a third weighting parameter for the divergence loss component.

Clause 14: The method of any one of Clauses 1-13, wherein the target domain feature extraction model is trained using a loss function comprising a regularization loss component.

Clause 15: The method of any one of Clauses 1-14, wherein the regularization loss component comprises a Euclidean distance function.

Clause 16: The method of any one of Clauses 1-15, wherein the loss function further comprises a cross-entropy loss component.

Clause 17: The method of any one of Clauses 1-16, wherein for a given sample, the cross-entropy loss component is configured to generate a cross-entropy loss value based on a positive feature generated by the mask generation model based on the given sample and a classification output generated by a linear classification model based on the given sample.

Clause 18: The method of any one of Clauses 1-17, wherein the loss function further comprises a weighting parameter for the regularization loss component.

Clause 19: The method of any one of Clauses 1-18, wherein the target domain feature extraction model comprises a neural network model.

Clause 20: The method of any one of Clauses 1-19, further comprising generating an inference using the target domain feature extraction model.

Clause 21: A method, comprising: tuning a target domain feature extraction model from a source domain feature extraction model trained on a source data set, wherein: the tuning is performed using a mask generation model trained on a target data set, and the tuning is performed using the target data set.

Clause 22: The method of Clause 21, further comprising any one of Clauses 2-20.

Clause 23: A system, comprising: a memory comprising computer-executable instructions; and one or more processors configured to execute the computer-executable instructions and cause the processing system to perform a method in accordance with any of Clauses 1-22.

Clause 24: A non-transitory computer-readable medium comprising computer-executable instructions that, when executed by one or more processors of a processing system, cause the processing system to perform a method in accordance with any of Clauses 1-22.

Clause 25: A computer program product embodied on a computer-readable storage medium comprising code for performing a method in accordance with any of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
tuning a target domain feature extraction model using a source domain feature extraction model trained on a source data set, wherein:
the tuning is performed using a mask generation model trained on a target data set, and
the tuning is performed using the target data set.

2. The method of claim 1, wherein the source domain feature extraction model is trained using a self-supervised loss function.

3. The method of claim 2, wherein the self-supervised loss function comprises a contrastive loss function.

4. The method of claim 3, further comprising augmenting the source data set by performing one or more transformations on one or more samples of the source data set.

5. The method of claim 1, wherein training the mask generation model comprises:
generating a set of positive features based on the target data set and the mask generation model; and
generating a set of negative features based on the target data set and the mask generation model.

6. The method of claim 5, further comprising:
generating a set of masks using the mask generation model; and
generating a set of binary masks based on the set of masks.

7. The method of claim 6, wherein generating the set of binary masks based on the set of masks comprises:
adding logistic noise to the set of masks; and
applying a nonlinear activation function to the set of masks.

8. The method of claim 7, wherein the nonlinear activation function comprises a sigmoid function.

9. The method of claim 5, wherein the mask generation model is trained using a loss function comprising a cross-entropy loss component based on the set of positive features.

10. The method of claim 9, wherein the loss function further comprises a maximum entropy loss component based on the set of negative features.

11. The method of claim 10, wherein the loss function further comprises a divergence loss component based on the set of positive features and the set of negative features.

12. The method of claim 11, wherein the loss function further comprises:
a first weighting parameter for the cross-entropy loss component;
a second weighting parameter for the maximum entropy loss component; and
a third weighting parameter for the divergence loss component.

13. The method of claim 1, wherein the target domain feature extraction model is trained using a loss function comprising a regularization loss component.

14. The method of claim 13, wherein the regularization loss component comprises a Euclidean distance function.

15. The method of claim 14, wherein the loss function further comprises a cross-entropy loss component.

16. The method of claim 15, wherein for a given sample, the cross-entropy loss component is configured to generate a cross-entropy loss value based on a positive feature generated by the mask generation model based on the given sample and a classification output generated by a linear classification model based on the given sample.

17. The method of claim 15, wherein the loss function further comprises a weighting parameter for the regularization loss component.

18. The method of claim 1, wherein the target domain feature extraction model comprises a neural network model.

19. The method of claim 1, further comprising generating an inference using the target domain feature extraction model.

20. A processing system, comprising:
a memory comprising computer-executable instructions; and
one or more processors configured to execute the computer-executable instructions and cause the processing system to perform an operation comprising:
tuning a target domain feature extraction model using a source domain feature extraction model trained on a source data set, wherein:
the tuning is performed using a mask generation model trained on a target data set, and
the tuning is performed using the target data set.

21. The processing system of claim 20, wherein the source domain feature extraction model is trained using a self-supervised loss function.

22. The processing system of claim 21, wherein the self-supervised loss function comprises a contrastive loss function.

23. The processing system of claim 22, the operation further comprising augmenting the source data set by performing one or more transformations on one or more samples of the source data set.

24. The processing system of claim 20, wherein training the mask generation model comprises:
generating a set of positive features based on the target data set and the mask generation model;
generating a set of negative features based on the target data set and the mask generation model;
generating a set of masks using the mask generation model; and
generating a set of binary masks based on the set of masks.

25. The processing system of claim 24, wherein generating the set of binary masks based on the set of masks comprises:
adding logistic noise to the set of masks; and
applying a nonlinear activation function to the set of masks.

26. The processing system of claim 25, wherein the mask generation model is trained using a loss function, comprising:
a cross-entropy loss component based on the set of positive features;
a maximum entropy loss component based on the set of negative features; and
a divergence loss component based on the set of positive features and the set of negative features.

27. The processing system of claim 26, wherein the loss function further comprises:
a first weighting parameter for the cross-entropy loss component;
a second weighting parameter for the maximum entropy loss component; and
a third weighting parameter for the divergence loss component.

28. The processing system of claim 20, wherein:
the target domain feature extraction model is trained using a loss function comprising a regularization loss component, and
the regularization loss component comprises a Euclidean distance function.

29. The processing system of claim 20, wherein the operation further comprises generating an inference using the target domain feature extraction model.
